(19) United States
(12) Patent Application Publication
(10) Pub. No.: US 2004/0264777 A1
(43) Pub. Date: Dec. 30, 2004

(54) 3D model retrieval method and system

(75) Inventors: Yukito Furuhashi, Hachioji-shi (JP); Mikihiko Terashima, Hachioji-shi (JP); Hiroshi Matsuzaki, Hachioji-shi (JP); Takao Shibasaki, Tokyo (JP)

Correspondence Address: SCULLY SCOTT MURPHY & PRESSER, PC, 400 GARDEN CITY PLAZA, GARDEN CITY, NY, 11530

(73) Assignee: OLYMPUS CORPORATION, TOKYO (JP)

(21) Appl. No.: 10/791,473

(22) Filed: Mar. 2, 2004

(30) Foreign Application Priority Data
Mar. 5, 2003 (JP) 2003-058313
Feb. 13, 2004 (JP) 2004-035917

(51) Int. Cl. G06K 9/66

(52) U.S. Cl. 382/190

(57) ABSTRACT

A 3D model similar to the specified 3D model is retrieved from a plurality of 3D models stored as objects to be retrieved in a database by using various feature values calculated from the selected 3D model. At that time, when at least one of the selected 3D model and a subelement which is a part of the selected 3D model is specified as a retrieval key, the feature values of the subelements included in the 3D model specified as the retrieval key and data on information about the relationship between the subelements are acquired. In addition, the feature values of the subelements included in the 3D models stored as objects to be retrieved in the database and data on information about the relationship between the subelements are acquired. Then, the similarity between the 3D models to be retrieved and the 3D model acting as retrieval key is calculated using the acquired feature values about the subelements to be retrieved, the acquired data on information about the relationship between the subelements, the acquired feature values about the subelements of the retrieval key, and the acquired data on information about the relationship between the subelements. On the basis of the calculated similarity, the result of retrieval is displayed.

### CROSS-REFERENCE TO RELATED APPLICATIONS

This application is based upon and claims the benefit of priority from prior Japanese Patent Applications No. 2003-058313, filed Mar. 5, 2003; and No. 2004-035917, filed Feb. 13, 2004, the entire contents of both of which are incorporated herein by reference.

### BACKGROUND OF THE INVENTION

1. Field of the Invention

This invention relates to a method of and a system for retrieving a similar object by using various feature values a three-dimensional (3D) model has, and more particularly to a method of and a system for retrieving a partially similar 3D model by using the relationship between the subelements set in a 3D model.

2. Description of the Related Art

In recent years, multimedia object data including still pictures, movies, sound, and music, as digital data, have been used in various scenes. For instance, as for data representing 3D objects, not only conventional CAD data but also 3D object data about commodities have been widely used. In addition, the digitization of archeological heritage, art objects, and works of art digitized into 3D object data to establish digital archives has been popularized. The mount of these types of data has steadily increased, thus there have been increasing needs for efficient data management and efficient retrieval of data requested by the user. To meet these needs, various techniques have been proposed. Concerning the techniques for retrieving similar objects, many retrieval methods have been proposed which calculate the features of multimedia objects in feature values expressed in numeric values and use multidimensional vectors composed of the feature values.

In the retrieval of a similar object using feature values, the user specifies an object subjectively similar to the desired object as the result of the retrieval. Then, the feature value of the specified object is compared with the feature value of the object registered in a database, which enables a similar object to be retrieved.

Furthermore, various products have nowadays been designed using CAD. A system has been proposed which registers the 3D form data and the component parts of the products in a database and retrieves similar products and parts. For example, in US 2002/0004710 A1, a system has been proposed which retrieves an object partially coinciding with a 3D form model composed of polygon. In this system, a form analyzing tree is constructed using an adjacent node as a parent node, with a node including polygon as a reference, and the consistency of a node in the form analyzing tree is evaluated, thereby determining the similarity of the 3D form. With this approach, for example, a search can be made using a mechanical part made by CAD as a retrieval key and then an object including a part obtained by additionally processing the machine part as a subelement can be obtained as a similar result.

### BRIEF SUMMARY OF THE INVENTION

According to a first embodiment of the present invention, there is provided a 3D model retrieval method of retrieving a 3D model similar to the specified 3D model from a plurality of 3D models stored as objects to be retrieved in a database by using various feature values calculated from the selected 3D model. The 3D model retrieval method comprises: specifying at least one of the selected 3D model and a subelement which is a part of the selected 3D model as a retrieval key; acquiring the feature values of the subelements included in the 3D model specified as the retrieval key and data on information about the relationship between the subelements; acquiring the feature values of the subelements included in the 3D models stored as objects to be retrieved in the database and data on information about the relationship between the subelements; calculating the degree of similarity between the 3D models to be retrieved and the 3D model acting as the retrieval key using the acquired feature values about the subelements to be retrieved, the acquired data on information about the relationship between the subelements, the acquired feature values about the subelements of the retrieval key, and the acquired data on information about the relationship between the subelements; and displaying the result of retrieval on the basis of the calculated similarity.

According to a second embodiment of the present invention, there is provided a 3D model retrieval system for retrieving a 3D model similar to the specified 3D model from a plurality of 3D models stored as objects to be retrieved in a database by using various feature values calculated from the selected 3D model. The 3D model retrieval system comprises: a catalogue selecting section configured to specify at least one of the selected 3D model and a subelement which is a part of the selected 3D model as a retrieval key; a retrieval key feature values acquisition section configured to acquire the feature values of the subelements included in the 3D model specified as the retrieval key at the catalogue selecting section and data on information about the relationship between the subelements; a retrieval object feature values acquisition section configured to acquire the feature values of the subelements included in the 3D models stored as objects to be retrieved in the database and data on information about the relationship between the subelements; a degree-of-similarity computing section configured to calculate the similarity between the 3D models to be retrieved and the 3D model acting as retrieval key using the feature values about the subelements to be retrieved and data on information about the relationship between the subelements acquired by the retrieval key feature values acquisition section and the feature values about the subelements of the retrieval key and data on information about the relationship between the subelements acquired by the retrieval object feature values acquisition section; and a display section configured to display the result of retrieval on the basis of the similarity calculated by the degree-of-similarity computing section.

According to a third embodiment of the present invention, there is provided a 3D model retrieval system for retrieving a 3D model similar to the specified 3D model from a plurality of 3D models stored as objects to be retrieved in a database by using various feature values calculated from the selected 3D model. The 3D model retrieval system comprises: catalogue selecting means for specifying at least one of the selected 3D model and a subelement which is a part of the selected 3D model as a retrieval key; retrieval key feature values acquiring means for acquiring the feature values of the subelements included in the 3D model specified as the retrieval key at the catalogue selecting means and data on information about the relationship between the subelements; retrieval object feature values acquiring means for acquiring the feature values of the subelements included in the 3D models stored as objects to be retrieved in the database and data on information about the relationship between the subelements; degree-of-similarity computing means for calculating the similarity between the 3D models to be retrieved and the 3D model acting as retrieval key using the feature values about the subelements to be retrieved and data on information about the relationship between the subelements acquired by the retrieval key feature values acquisition means and the feature values about the subelements of the retrieval key and data on information about the relationship between the subelements acquired by the retrieval object feature values acquiring means; and display means for displaying the result of retrieval on the basis of the similarity calculated by the degree-of-similarity computing means.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows the configuration of a 3D interior simulation system to which a 3D model retrieval method and system according to a first embodiment of the present invention have been applied;

FIG. 2 shows an example of 3D form data;

FIG. 3 shows information on the relationship between subelements;

FIG. 4 shows the procedure for interior simulation;

FIG. 5 shows a displayed state of a layout sample in selecting an item at the editing section;

FIG. 6 shows a window displaying a tree structure of the layout sample;

FIG. 7 shows the procedure for a similarity retrieving process;

FIG. 8 shows a window displaying the result of the retrieval;

FIG. 9 is a diagram showing the procedure to help explain a method of rotating the posture of 3D form data;

FIG. 10 shows the coordinate relationship between the display screen and 3D form data;

FIG. 11 shows the procedure for transition of the displayed state of a 3D model specified as a retrieval key;

FIG. 12 shows the procedure for highlighting the retrieval key according to the retrieval key specify operation when there is a subelement behind the click position in a second embodiment of the present invention;

FIG. 13 shows an example of highlighting;

FIG. 14 shows a retrieval key and the results of retrieval in a third embodiment of the present invention;

FIG. 15 shows the procedure for displaying the result of retrieval;

FIG. 16A shows an example of displaying information about the relationship between the subelements set in a 3D model in a fourth embodiment of the present invention, in a case where a tab for showing relationship information focusing on the layout has been selected;

FIG. 16B shows an example of displaying relationship information when the tab for displaying relationship information focusing on the structure has been selected;

FIG. 17 shows a tree structure and a data format to help explain subelements not shown in tabs;

FIG. 18 shows an example of displaying relationship information when the tab for displaying relationship information focusing on information unrelated to 3D model forms has been selected;

FIG. 19 shows a retrieval key 3D model and a retrieval object 3D model used in a fifth embodiment of the present invention;

FIG. 20 shows relationship information on the retrieval key 3D model;

FIG. 21 shows the procedure for retrieving a 3D model similar to the retrieval key;

FIG. 22 shows drawings to help explain the editing of subelements and the retrieval result 3D model in a sixth embodiment of the present invention;

FIG. 23 shows the configuration of an accessory order system to which a 3D model retrieval method and system according to a seventh embodiment of the present invention have been applied;

FIG. 24 shows an example of 3D form data;

FIG. 25 shows the procedure for a retrieving process; and

FIG. 26 shows a retrieval key and the result of retrieval.

### DETAILED DESCRIPTION OF THE INVENTION

Hereinafter, referring to the accompanying drawings, embodiments of the present invention will be explained.

### FIRST EMBODIMENT

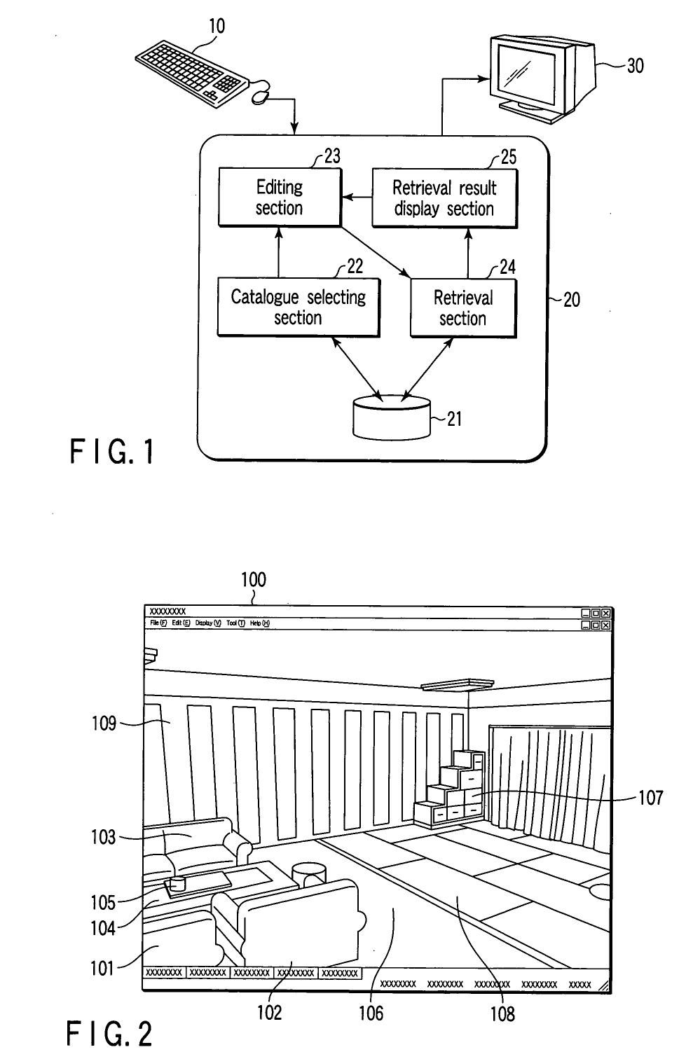

As shown in FIG. 1, a 3D interior simulation system to which a 3D model retrieval method and system according to a first embodiment of the present invention have been applied comprises an input section 10, a simulation section 20, and an output section 30. The input section 10 and output section 30 are connected to the simulation section 20. The input section 10 and output section 30 correspond to a keyboard, a mouse, and a display in an ordinary computer system.

The simulation section 20 includes a database 21, a catalogue selecting section 22, an editing section 23, a retrieval section 24, and a retrieval result display section 25. The database 21 is connected to the catalogue selecting section 22 and retrieval section 24. The retrieval section 24 calculates the similarity by comparing a key object with feature values in the database 21. In the database 21, various interior layout samples have been registered. The registered contents registered include 3D form data, feature values, and attribute information. The catalogue select section 22, editing section 23, retrieval section 24, and retrieval result display section 25 are realized by, for example, corresponding program functions or may be realized by providing separate dedicated circuits. Alternatively, the catalogue select section 22, editing section 23, retrieval section 24, and retrieval result display section 25 may be put-in separate housings and constitute the simulation section 20 by connecting the signals from them.

In this specification, the term “feature value” means a value that can be calculated by processing a 3D model arithmetically. For example, “feature value” includes the surface area, volume, vertex probability distribution, and surface texture/color distribution for 3D data. It further includes a moment histogram around a circumscribed ellipsoid major axis for 3D data. The attribute information includes the name of all of the layout samples, the names of 3D model subelements, and prices. The term “subelement” means data on a part of the 3D model. The term “information on the relationship between subelements” used in the explanation below means the connection relationship in form and/or meaning between the subelements set in a 3D model. A subelement can have an inclusive relation with another subelement. It can further define a connection relationship with another subelement. These relations are called relationship information. For example, a tree structure is one example of structured (hierarchized) relationship information. However, relationship information is not limited to this.

FIG. 2 shows an example of the 3D form data. Interior data 100 is composed of a plurality of subelements, part of which are indicated by reference numbers 101 to 109. These subelements 101 to 109 themselves are 3D form data.

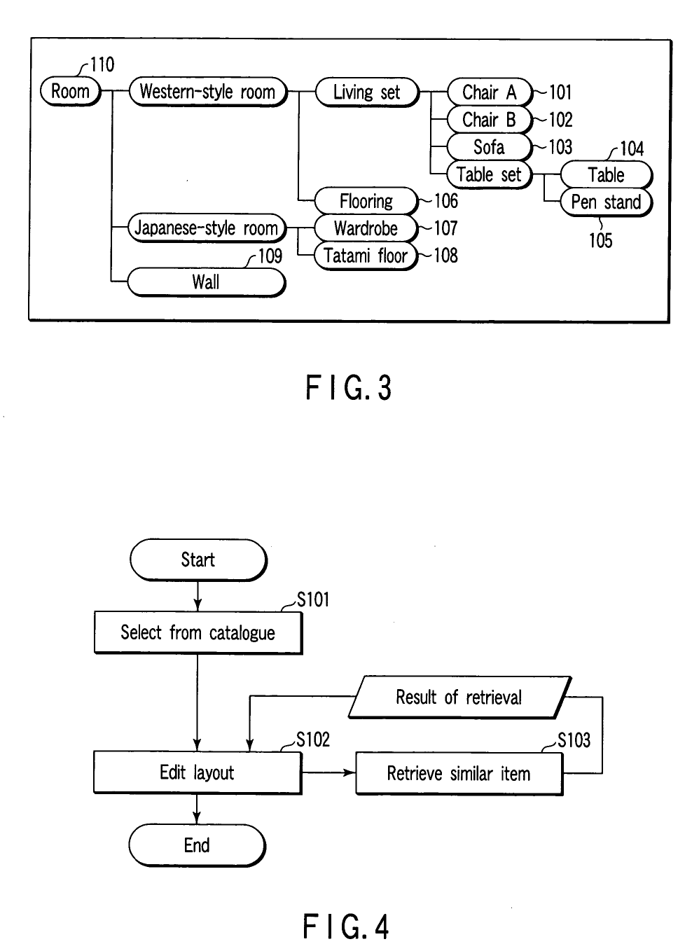

In addition, the interior data 100 has relationship information 110 about the subelements as shown in FIG. 3. The relationship information 110 is represented by a tree structure where the set of the individual subelements is structured (hierarchized). That is, the subelements in the tree structure can be treated as nodes which connect subelements higher in level than the present ones with subelements lower in level than the present ones. The relationship information about the subelements 101 to 109 is not restricted to such a tree structure and further includes a graph where the relationship between subelements makes a loop.

The catalogue selecting section 22 is connected to the editing section 23. The retrieval section 24 is connected to the editing section 23 and retrieval result display section 25. The retrieval result display section 25 is connected to the editing section 23. The 3D interior simulation system is configured as described above.

Next, the operation of the first embodiment will be explained. The procedure for interior simulation by the 3D interior simulation system is shown in FIG. 4. In step S101, the user selects the desired layout sample from the catalogue selecting section 22. The selected layout sample is sent to the editing section 23.

A plurality of layout samples have been registered in the database 21. By a display representation of the layout sample select mode, a plurality of layout samples are shown on the display in the form of thumbnails. By scrolling the screen, many layout samples can be browsed. As for the interior, a single model select mode can be displayed for individual models, for example, a chair and a table. In this mode, thumbnails are displayed, the user's desired model is selected, and individual models are replaced for the layout sample, thereby making it possible to do interior changing simulation. In the layout changing method, for example, when a table to be replaced is selected from the thumbnails, the table selected for change is placed in the desired position in the layout on the display by a drag and drop operation. At this time, the size of the model is adjusted so as to have a suitable size in the interior layout. The table is adjusted in an up and down direction automatically. The direction of the table is set to a suitable one desired by the user by using an operation control. At this time, for example, there is such a function of placing the table in an exact position automatically, if it is placed near the floor, when the table is not placed three-dimensionally in the exact position on the floor face. Next, for example, a pen stand is selected and dragged and dropped in the desired position on the screen in a similar manner. In this state, when the user selects the table and the pen stand and clicks “Associate” button, an association window is opened. On the association window, for example, the user enters a name, such as “Table set,” and presses “OK” button, thereby associating the table with the pen stand, which completes the association “Table set.” By performing similar operations, it is possible to set association information for an arbitrary model. In addition, there in a table set in the higher-level nodes of the table. In the levels higher than the pen stand, there is a table set. In this case, there is a function of, when the table and the pen stand are placed close to each other on the screen, associating them with each other in the system automatically.

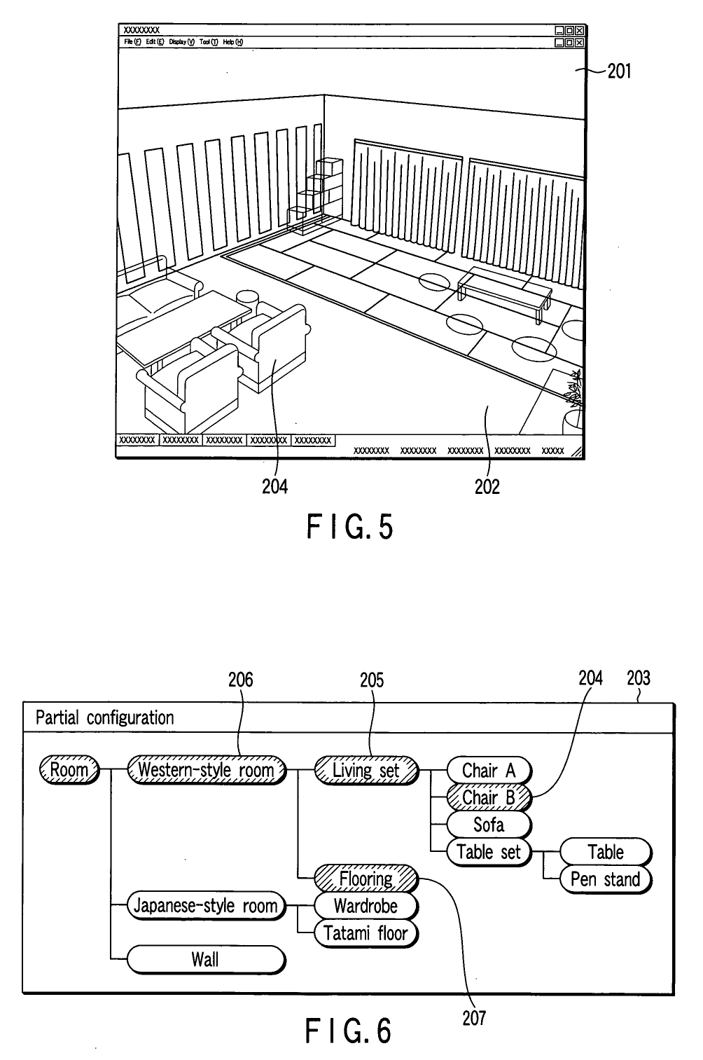

In step S102, the modification of the room and the change, arrangement, and the like of interior items are made on the basis of the layout sample sent to the editing section 23. The operation of selecting an item in changing interior items will be explained. At the editing section 23, the items on the layout sample displayed on the display of the output section 30 can be selected with the mouse in the input section 10. FIG. 5 shows a displayed state in selecting an item at the editing section 23. In the window 201, the layout sample 202 selected in step S101 is shown as a 3D model. The layout sample 202 has a tree structure as shown in the window 203 of FIG. 6 (the window 203 is displayed in a case explained later and usually is not displayed). When the user clicks on an item, for example, “Chair B” 204, in the layout sample 202 with the mouse, “Chair B” 204, a subelement of the layout sample 202 is highlighted as the selected part. When the user clicks on the “Chair B” 204 successively, the selected part becomes “Living set” 205 according to the hierarchy of the tree structure shown in the window 203. In this state, the subelements “Chair A,” “Chair B,” “Sofa,” “Table,” and “Pen stand” included in “Living set” 205 are highlighted. When the user further clicks on “Chair B” 204 successively, the selected part becomes “Western-style room” 206 according to the hierarchy of the tree structure of FIG. 203. As described above, when the user clicks the first clicked item successively, the selected part moves toward the higher level of the tree structure. At this time, the highlighted parts in the window 201 become all of the subelements included in the selected part.

In this specification, the term “highlight” means subjecting a specific subelement to display-related processes in drawing a 3D model on the screen. For example, highlighting means a method of drawing the selected part opaquely and the remaining part translucently. In addition to this, there is a method of providing a surface display of the selected part and a wire frame display of the remaining part, a method of displaying the selected part brightly and the remaining part darkly, and a method of shading the selected part so as to cover the outline the selected part with a white belt. The user can set one of the highlighting methods arbitrarily.

Furthermore, there is a case where another item is present behind the clicked item, that is, a case where, when a perpendicular line is dropped from the clicked position, there are a plurality of 3D objects contacting the perpendicular line. In such a case, the window 203 showing a partial configuration is displayed on the display of the output section 30. In the window 203, relationship information about the subelements of the layout sample 202 is represented by a tree structure. In the tree structure, a system having the clicked item and an item behind the clicked item at its ends is highlighted. The user can determine the subelement to be selected by clicking on the element in the window 201 again. The displayed state of the tree structure shown in the window 203 of FIG. 6 appears when the user clicks on “Chair B” 204. At this time, since “Flooring” 207 is present behind “Chair B” 204, the system having the two at its ends is highlighted.

In this way, after the modification of the room and the change, arrangement and the like of interior items have been made at the editing section 23, the database 21, in step S103, is searched for similarities using the subelement selected in step S102 as the retrieval key. At the same time, the result of the similarity retrieval is displayed on the display of the output section 30. In this specification, the term “retrieval key” means a retrieval condition set by the user. For example, the 3D model specified by the user in doing a search corresponds to the retrieval key.

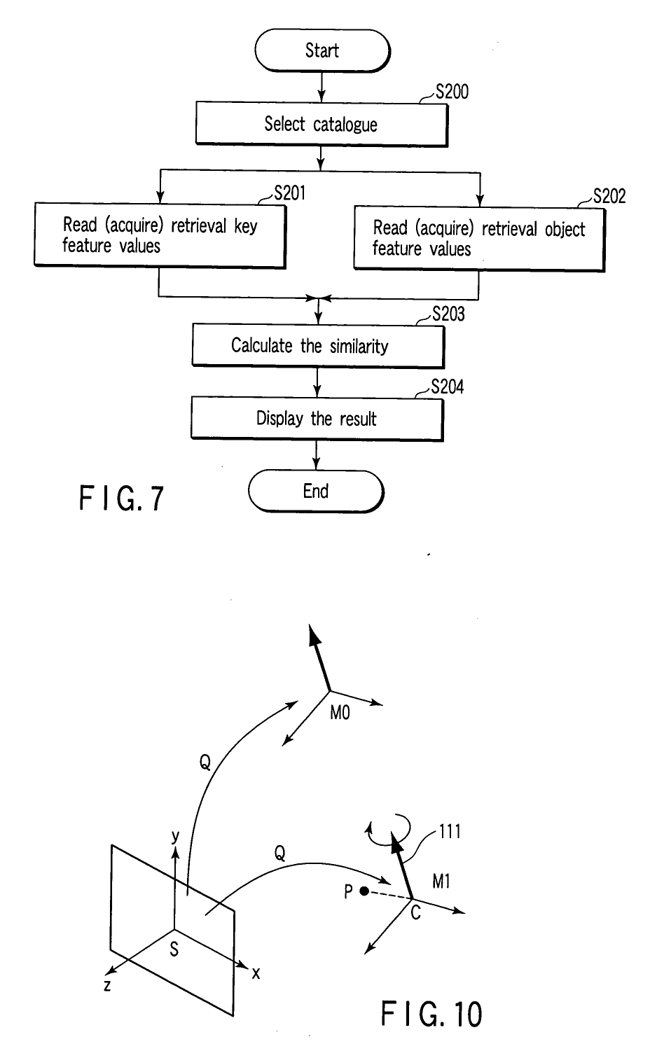

The similarity retrieval is performed at the retrieval section 24. The step of performing similarity retrieval is shown in FIG. 7. In step S200, the user selects a model for which a similar one is to be retrieved. In step S201, the feature values corresponding to the subelement of the 3D model acting as the retrieval key are read from the database 21. Step S201 further includes the process of, when the calculated and registered feature value has not been registered in the database 21, calculating a new feature value and obtaining the necessary feature value. In step S202, the feature values about the registered layout sample to be retrieved are read from the database 21. Step S202 further includes the process of, when the calculated feature value has not been registered in the database 21, calculating a new feature value and obtaining the necessary feature value. The feature values are calculated for each of the subelements of the layout sample. For example, the individual nodes of the tree structure as shown in the window 203 are independent feature values items.

In step S203, the similarity is calculated from the feature values read in step S201 and step S202. In calculating the similarity, the difference feature value, or the difference between the feature value of the subelement acting as the retrieval key and the feature value of each 3D model to be retrieved, is calculated. The difference feature value is expressed as a vector whose number of dimensions is equal to the number of feature values. Next, the magnitude of the difference feature value is calculated as the similarity corresponding to the subelement of each 3D model. In step S204, the subelement of each 3D model is sorted on the basis of the similarity calculated in step S203. The result of the retrieval is transmitted to the retrieval result display section 25. At the time of transmission, the result of the transmission may be limited by a threshold value set by the user or the system.

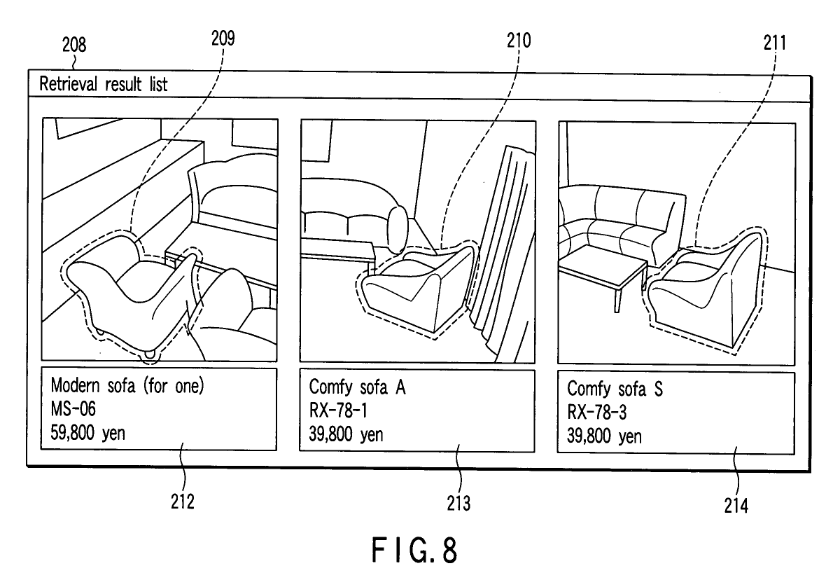

The retrieval result display section 25 displays the results of the retrieval sorted in the order of similarity on the display of the output section 30 in the form of a 3D model in the window 208 as shown in FIG. 8. In FIG. 8, top three of 3D models whose similarity is lower than the threshold value are shown. In the retrieval result 3D model, the subelements 209 to 211 whose similarity has been calculated are highlighted. In the field below each retrieval result 3D model, the attribute information 212 to 214 set in the highlighted subelements 209 to 211 are shown. The highlighting method is to display opaquely the subelements to be highlighted and the remaining part translucently. At this time, the 3D form data, the result of the retrieval, has been rotated so that the subelement to be highlighted may be hithermost, with the posture of the vertical axis being kept. With the posture, the 3D model is displayed when the retrieval key has been specified at the editing section 23.

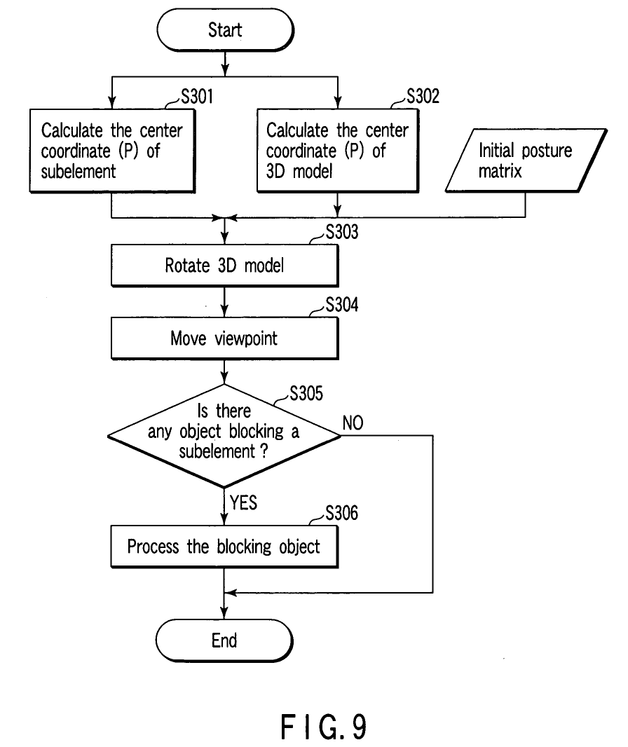

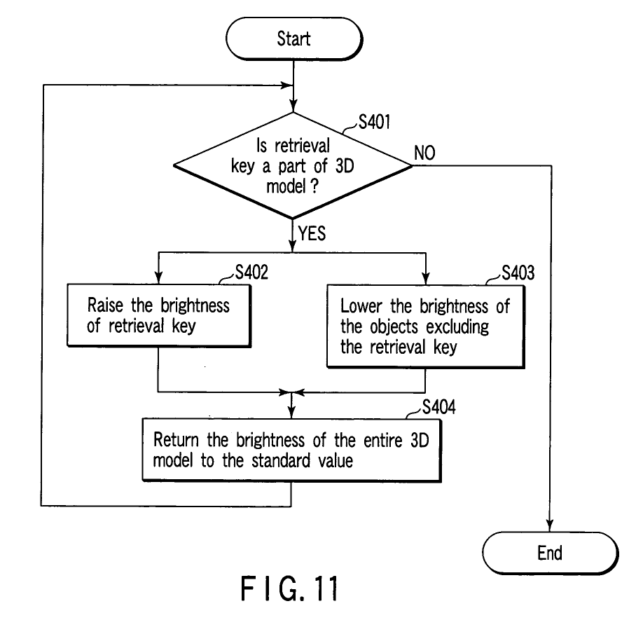

The procedure for the method of rotating the posture of the 3D form data for highlighting is shown in FIG. 9. The coordinate relationship between the display screen and the 3D form data is shown in FIG. 10. In step S301, the center coordinate “P” of a subelement to be highlighted is calculated. In step S302, the center coordinate “C” of all of the 3D form data to be displayed is calculated. In step S303, all of the 3D form is rotated, centering on the calculated center coordinate “C.” The rotating process will be explained below. The models registered in the database in the initial stages do not necessarily have the same posture. After pieces of the posture information are made equal by the editing operation in a postprocess, a search is made. The editing section 23 obtains an initial posture matrix which expresses the posture of a 3D model when the retrieval key is specified at the editing section 23. The initial posture matrix “Q” is a rotation matrix of 3 rows×3 columns which has the function of rotating from the coordinate system “S” of the display screen to the coordinate system “M0” of the 3D model acting as the retrieval key. Next, the initial posture matrix “Q” is applied to all of the 3D form data to be displayed. As a result, the coordinate system “M1” of the 3D form data takes the same posture as that of the retrieval key. Next, with the center coordinate “C” at the center, the 3D form data is rotated on the vertical axis 111 of the coordinate system “M1.” At this time, the 3D form data is brought into the posture which maximizes the Z coordinate of the center coordinate “P” on the coordinate system “S.” The reason why the Z coordinate is maximized is that an ordinary model aligned in the Z coordinate, or depth direction, looks the most natural. Therefore, the Z coordinate is not necessarily maximized. It may be possible to use a method of setting such a coordinate system as maximizes the X, Y, and Z coordinates, calculating the similarity in each case, and outputting the case with the highest similarity as the result of the retrieval.

In step S304, the 3D form data is translated so that the subelement to be highlighted may become the center of the visual field. In step S305, it is determined whether there is another subelement in front of the subelement to be highlighted. If there is not another subelement, the process is ended. In contrast, when there is another subelement, another subelement is subjected to a display-related process in step S306. In the 3D interior simulation system, transparency of the subelements is made 100%, thereby bringing the subelements into a completely transparent state. In addition, of the subelements, the part shielding the subelement to be highlighted may be brought into the cutoff state according to the user's instruction. By this process, the subelement to be highlighted is displayed without being hidden.

After step S103, control returns to step S102 again, where the result of the retrieval of the 3D model displayed in the window 208 of FIG. 8 can be loaded into the window 201 of FIG. 5. The user can repeat step S102 and step S103 until the desired interior layout has been completed.

The similarity is calculated using the equation below. To actually make a search, a vector having the calculated features as components is used as a feature vector and the similarity is calculated using the feature vector. A concrete similarity information retrieval method can be explained using FIG. 1. When object data is inputted at the input section 10, the retrieval section 24 functioning as a feature value computing section and a database registering section does the work of calculating the feature value and registering the feature vector. In addition, the retrieval section 24, which also functions as a degree-of-similarity computing section, compares the feature vector obtained from the input object data with all of the feature vectors in the database 21 to be searched. Then, the retrieval result display section 25 outputs the results of the retrieval to the output section 30 in the order of similarity.

If the number of features f₁ to f_{M} calculated at the retrieval section 24 is M and the number of data items I₁ to I_{N} in the database 20 to be searched is N, a feature value matrix F is expressed by the following equation (1):

$$F = ( \begin{matrix}{F}_{11} & {F}_{12} & ⋯ & {F}_{1 p} & ⋯ & {F}_{1 m} \\ {F}_{21} & ⋰ & & ⋮ & & \\ ⋮ & & ⋰ & ⋮ & & \\ {F}_{q1} & ⋯ & ⋯ & {F}_{qp} & & \\ ⋮ & & & & ⋰ & \\ {F}_{n1} & & & & & {F}_{n m}\end{matrix} ) \qquad ( 1 )$$

The feature value vector \vec{f_{q}} of a q-th object data item I_{q} is expressed by the following equation (2):

$$\vec{{f}_{q}} = {\sum }_{j = 1}^{M} {w}_{j} \cdot \{ {k}_{j} \cdot ( {F}_{qj} - \overline{{F}_{j}} ) \} \cdot \vec{{i}_{j}} \qquad ( 2 )$$

In the equation (2), multiplying by kⱼ causes each feature term to be normalized.

When the feature value distribution deviates greatly from the normal distribution, or when the value of feature deviates much more greatly from the average than from the standard deviation value, it is concealable that the feature has such a great effect that an accurate comparison cannot be made. To solve this problem, a limiter function D(x) is introduced into equation (3):

$$\vec{{f}_{q}} = {\sum }_{j = 1}^{M} {w}_{j} \cdot \{ D ( {k}_{j} \cdot ( {F}_{qj} - \overline{{F}_{j}} ) ) \} \cdot \vec{{i}_{j}} \qquad ( 3 )$$

$$D ( x ) = \{ \begin{matrix}x & \vert x \vert \leq d \\ d & \vert x \vert > d\end{matrix}$$

(d is separately determined as a suitable value) where a unit vector iₚ in each feature value direction satisfies the expressions:

∀p,q(p≠q), iₚ⊥i_{q}

where the weighting factors for the individual dimensions are w₁ to w_{M}. Moreover, it follows that

$$\begin{matrix}\overline{{F}_{p}} = \frac{1}{N} {\sum }_{j = 1}^{N} {F}_{jp} \\ {v}_{p} = \frac{1}{N} {\sum }_{j = 1}^{N} {( {F}_{jp} - \overline{{F}_{p}} )}^{2}\end{matrix}$$

σₚ=\sqrt{Vₚ}

$${k}_{p} = \frac{1}{{σ}_{p}}$$

In this specification, the term “weighting factor” means a value representing the order of importance of feature value.

If a feature vector is given using equation (2) or equation (3), the similarity S_{pq} of the object Oₚ with respect to the object O_{q} can be expressed as:

Sim_{pq}=∥\vec{f}ₚ−\vec{f}_{q}∥

This means that, the smaller Sim(p,q), the higher the similarity. This function is calculated for all of the images in the database, which enables the order of similarity to be determined. This work is done at the retrieval section 24 functioning as the degree-of-similarity computing section. Then, the retrieval result display section 25 rearranges the objects in the order of similarity and displays the result on the output section 30, thereby retrieving the similarity information.

While each element in the matrix expressed by equation (1) is scalar quantity, some are significant in terms of histograms or vectors, depending on the defined feature. In such a case, they are treated as vector quantities. The vector difference between them and inquiry objects is calculated. This quantity is defined as scalar quantity again, thereby re-creating the matrix expressed by equation (1). Specifically, if (F_{pq1}, F_{pq2}, . . . , F_{pqx}) is a histogram or a vector feature, when the similarity for object number p is calculated, the following is used again as a feature element:

$${F}_{{p}_{q}} = \sqrt{{\sum }_{k = 1}^{x} {( {F}_{{p}_{{q}_{k}}} - {F}_{{pq}_{k}} )}^{2}}$$

Next, the effects of the first embodiment will be explained. The user of the 3D interior simulation system specifies a part of a 3D model at the editing section 23 and makes a search, which makes it possible to acquire an interior item partially similar to the 3D model registered in the database 21. Specifically, for example, even if the 3D model registered in the database 21 is all of the interior samples, it is possible to retrieve a chair or a table, a part of the 3D model. In a conventional approach, an object to be retrieved is divided using a polygon as the smallest unit. Subelements are constructed on the basis of the adjacent relationship between polygons. Consequently, an object different from what a person recognizes as an independent subelement, for example, a combination of a part of a chair and a part of a floor, is included as noise in the result of the retrieval. This is because the unit a person recognizes as a subelement differs from the unit the conventional approach recognizes as a subelement. On the other hand, in the 3D interior simulation system to which the present embodiment has been applied, subelements to be retrieved are constructed on the basis of the relationship information about the subelements preset in the 3D model as shown in the window 203 of FIG. 6. Usually, the subelements set in the 3D model are units recognized by a person as subelements. Therefore, the subelements recognized by the 3D interior simulation system as objects to be retrieved coincide with the units recognized by a person. As a result, what a person does not recognize as an independent subelement will not be included in the result of the retrieval of the 3D interior simulation system. Therefore, the user can get the desired interior item efficiently from the result of the retrieval with less noise.

Furthermore, since the relationship between the subelements set in the 3D model is used in specifying the retrieval key, an arbitrary subelement on the tree structure can be specified easily by a click operation. When the retrieval key was specified in the conventional approach, the whole of the 3D model was specified. In specifying a part of the 3D model, it was very difficult to specify the desired part accurately in the form of a set of polygons, since the smallest unit of a subelement was a polygon. On the other hand, in the 3D interior simulation system to which the present embodiment has been applied, the subelements of the 3D model are constructed on the basis of the relationship information 110 about the subelements preset in the 3D model as shown in the window 203 of FIG. 6. Therefore, the user need not specify the boundary between subelements accurately. Consequently, even if an interior item to be specified as a retrieval key is a part of the 3D model, the user can specify a part of the 3D model easily by a simple click operation and obtain the desired interior item efficiently.

Furthermore, when the user clicks on the 3D model to specify a retrieval key, the clicked position, together with the subelements behind it, is highlighted in the window 203 as shown in FIG. 6. Therefore, even if the interior item is in the back three-dimensionally, the user can specify it easily by using the relationship information about the subelements displayed in the window 203. When the user clicks on the 3D model in the window 201 of FIG. 5 to specify a retrieval key, the entire system which has the click position and the subelements behind it at its ends is highlighted. The tree structure, which is relationship information about the subelements set in the 3D model, generally represents a parent-child relationship recognized by a person. For example, “Chair B” 204 in FIG. 6 is included in “Living set” 205, which meets a parent-child relationship. Therefore, for example, when the user clicks the item “Chair B” 204 in the window 201 of FIG. 5, the subelement including “Chair B” 204 is highlighted as a system in the window 203, which makes it easy to select another related subelement.

In addition, in the 3D interior simulation system to which the present embodiment has been applied, the subelement selected to specify a retrieval key and the similar subelements included in the result of the retrieval are highlighted. With this display, the user can grasp the noteworthy subelements easily. Moreover, in the 3D interior simulation system to which the present embodiment has been applied, the result of the retrieval is displayed so as to be equal to the vertical posture in specifying the retrieval condition. That is, even when a similar subelement in the 3D model is rotated so that the subelement may be in the hithermost position, the top and bottom of the 3D model will never rotate. Therefore, the user can recognize easily the subelement determined to be similar from the result of the retrieval. Furthermore, in the 3D interior simulation system to which the present embodiment has been applied, attribute information about the subelement similar to the 3D model retrieved is displayed at the same time as shown in FIG. 8. That is, the user can obtain not only the 3D form of the subelement determined to be similar but also information including name and price. Therefore, it is easy to determine the usefulness of the result of the retrieval including the attribute information.

With the above effects, interior simulation can be done efficiently.

The retrieval result highlighting method includes not only the method of displaying opaquely the subelements to be highlighted and the remaining ones translucently but also the method of setting transparency according to the similarity of the subelements included in the result of the retrieval, the method of providing a surface display of the selected parts and a wire frame display of the remaining parts, the method of brightening the selected parts and darkening the remaining parts, and the method of shading the selected part so as to cover the outline of the selected part with a white belt. The user can select one of the highlighting methods arbitrarily.

### SECOND EMBODIMENT

Next, a second embodiment of the present invention will be explained. Since the configuration and operation of the second embodiment conform to the first embodiment, only the differences between them will be explained below. The second embodiment is such that there is provided means for highlighting a subelement of a 3D model to be specified as a retrieval key and a subelement of a 3D model to be displayed as the result of the retrieval by a different method from that of the first embodiment. In addition, the second embodiment uses a different method in the selecting method in specifying a retrieval key.

In the second embodiment, a 3D model specified as a retrieval key at the editing section 23 presents display state transition according to the procedure shown in FIG. 11. In step S401, it is determined whether the subelement specified as the retrieval key is a subelement of the 3D model. It is determined whether the specified model coincides with the entire model or a part of the entire model. If the retrieval key is not a part of the 3D model, that is, if the retrieval key coincides with the whole of the 3D model, the process is ended.

In contrast, if the retrieval key is a part of the 3D model, the brightness of the subelement specified as the retrieval key is raised in step S402. That is, raising the brightness causes the 3D model of the retrieval key to be displayed brightly. In step S403, of the 3D model, the brightness of the parts excluding the retrieval key is lowered. That is, lowering the brightness causes the parts excluding the retrieval key of the 3D model to be displayed darkly. In this way, the retrieval key and the remaining parts are displayed in such a manner that the former differs from the latter in brightness, thereby highlighting the subelement specified as the retrieval key. In step S404, the brightness of the total 3D model to be displayed is returned to the standard value, thereby achieving homogenization. In this state, the whole 3D model is displayed uniformly and the retrieval key is not highlighted. Thereafter, step S402 to step S404 are repeated unless the retrieval key is changed. As a result of the repetition, a visual effect is produced as if the retrieval key blinks.

The highlighting method is also used in displaying the result of retrieval at the retrieval result display section 25. In highlighting the result of retrieval, the retrieval key in FIG. 11 and the above step is replaced with the subelement determined to be similar. That is, on the display screen, a visual effect is produced as if the subelement determined to be similar blinks.

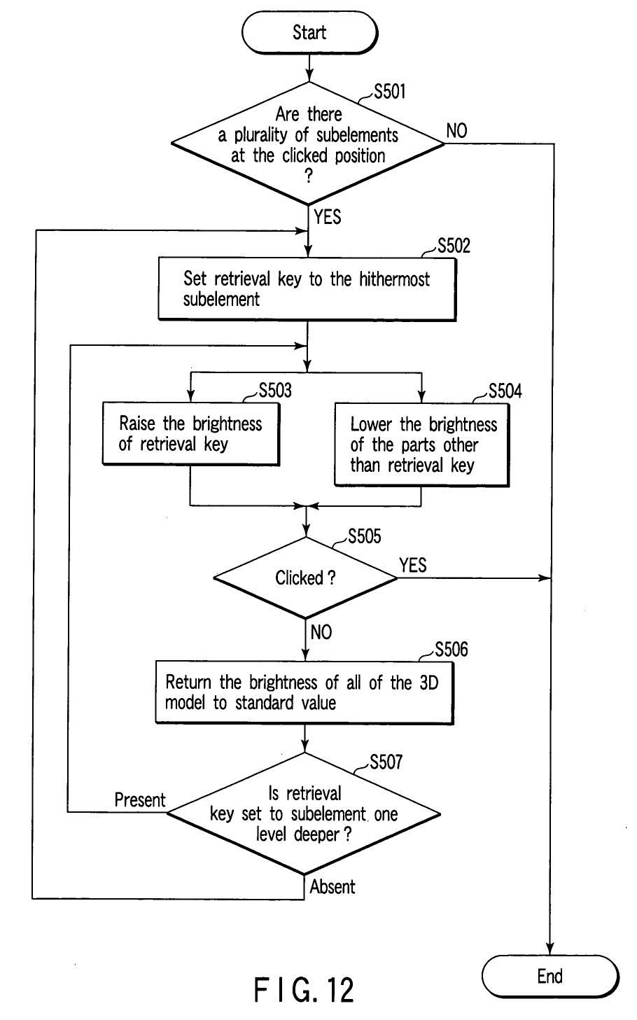

Next, using FIG. 12, a retrieval key specify operation and a retrieval key highlighting operation when there are subelements behind the clicked position will be explained. In step S501, it is determined whether there are subelements behind the clicked position. If there is no subelement behind the clicked position, the process is ended.

In contrast, if there are subelements behind the clicked position, the subelement in the hithermost position is set as the initial value of the retrieval key in step S502. Thereafter, in step S503, the brightness of the subelement acting as the retrieval key is increased. That is, increasing the brightness causes the 3D model of the retrieval key to be displayed brightly. In addition, in step S504, the brightness of the parts excluding the retrieval key is decreased. That is, decreasing the brightness causes the parts excluding the retrieval key to be displayed darkly. In this way, the retrieval key and the remaining parts are displayed in such a manner that the former differs from the latter in brightness, thereby highlighting the subelement specified as the retrieval key. In step S505, it is determined with highlighting timing whether another clicking has been done. If another clicking has been done, the set retrieval key is decided and the process is ended.

In contrast, if no clicking has been done, the brightness of all of the 3D model to be displayed is returned to the standard value, thereby achieving homogenization. In this state, the whole of the 3D model is displayed uniformly and the retrieval key is not highlighted. Then, in step S507, the retrieval key is changed from the present subelement to a subelement one level deeper than the present one. At this time, it is determined whether there is any subelement behind the present subelement. If there is no subelement behind the present one, the process proceeds to step S502, where the hithermost subelement is set as the retrieval key again. If there is a subelement behind the present one, the process goes to steps S503 and S504.

In step S505, step S502 to step S507 are repeated until it has been determined that clicking has been done. The repetition produces a visual effect that the retrieval key is changed toward a deeper level step by step, while blinking on the display screen. The user can decide the retrieval key by clicking the desired subelement again when it is highlighted.

Next, the effect of the second embodiment will be explained. In the 3D interior simulation system to which the second embodiment has been applied, the retrieval key highlighting state and the normal display state are alternated successively. Therefore, the user can recognize the retrieval key more easily than when only the retrieval key highlighting state is displayed. Similarly, as for the result of retrieval, the state where the subelement determined to be similar and the normal display state are alternated successively. Therefore, the user can recognize the subelement determined to be similar from the result of retrieval more easily than when only the state where the subelement determined to be similar is displayed. In addition, when the retrieval key is specified from the subelements lying one upon another in the depth direction, the retrieval key highlighting state and the normal display state are alternated successively, thereby changing the retrieval keys one after another. Therefore, even when the subelements lie behind the clicked position, the user can recognize them easily and set them as retrieval keys. With the above effects, the user can specify the retrieval key efficiently and do an interior simulation, while acquiring the desired interior items from the result of retrieval.

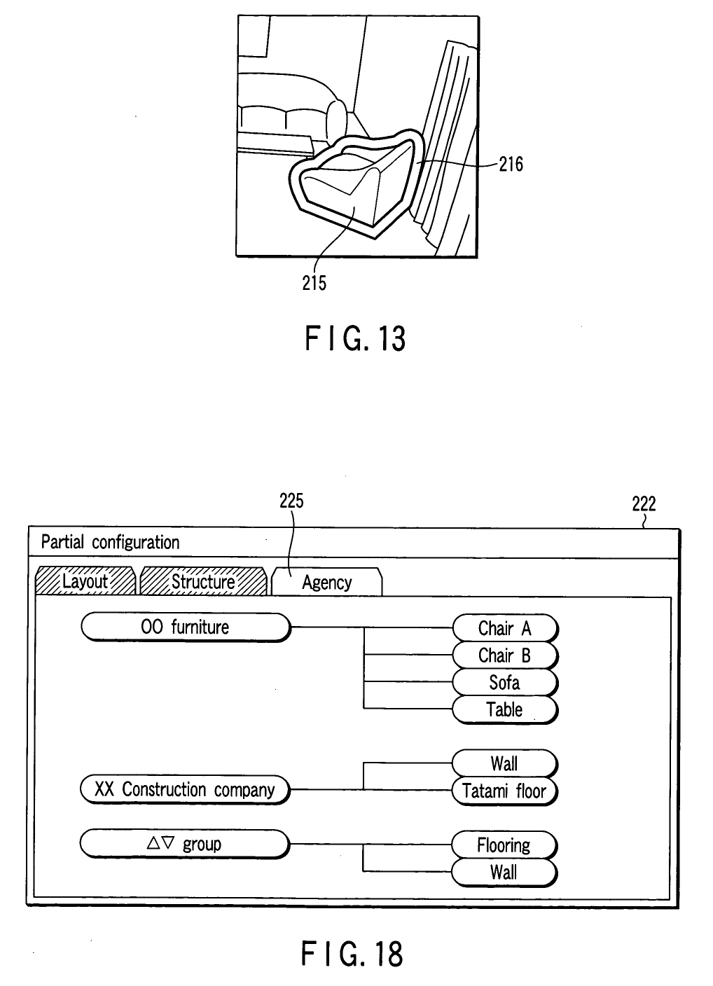

In the second embodiment, as the highlighting approach, the method has been used which raises the brightness of the parts to be emphasized, including the retrieval key and the subelement determined to be similar, and lowers the brightness of the remaining parts. The highlighting approach is not limited to this. For example, a method of making the part to be highlighted opaque and the remaining parts translucent may be used. In addition, a method of doing the surface rendering of the parts to be highlighted and the stipple rendering of the remaining parts may be used. Furthermore, a method of enclosing the outline of the part to be highlighted 215 with a white shade 216 as shown in FIG. 13 may be used. Enclosing the outline of the part to be highlighted 215 with a white shade 216 produces a visual effect of standing out against the surroundings.

In addition, the speed at which the processes in FIGS. 11 and 12 are repeated may be set by the user or the system.

### THIRD EMBODIMENT

Next, a third embodiment of the present invention will be explained. Since the configuration and operation of the third embodiment conform to the first embodiment, only the differences between them will be explained below. The third embodiment is such that the displaying method of the retrieval result display section 25 is made different from that in the first embodiment.

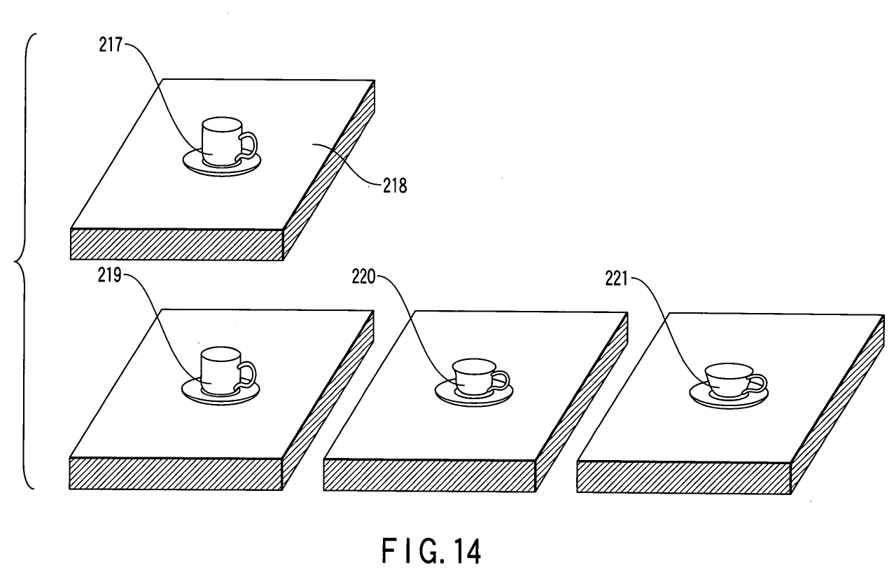

FIG. 14 shows a retrieval key and the result of retrieval. “Cup A” 217 is a subelement of a 3D model acting as a retrieval key. A table 218, which is a subelement of the same 3D model as “Cup A” 217, is not included in the retrieval key. Part of the results of retrieval at this time are “Cup B” 219, “Cup C” 220, and “Cup D” 221. These are the subelements determined to be similar to “Cup A” 217. The retrieval result display section 25 displays these cups on the output section 30 in such a manner that they are replaced with “Cup A” 217, the retrieval key. That is, they are displayed in such a manner that the retrieved “Cup B” 219, “Cup C” 2.20, and “Cup D” 221 are arranged on the table 218, a subelement of the same 3D model as “Cup A” 217.

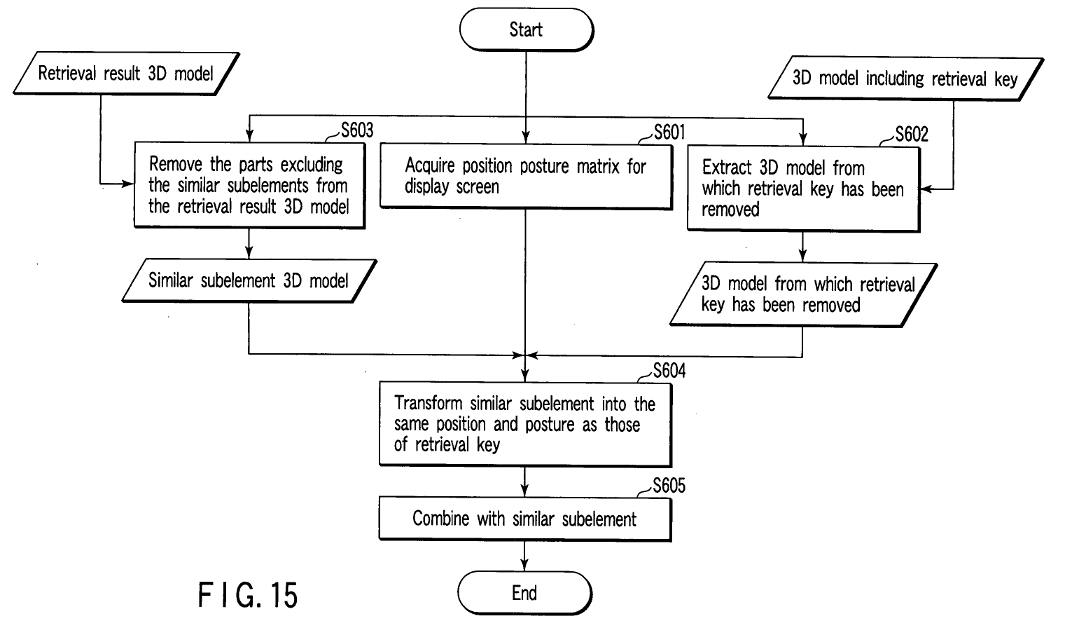

The procedure will be explained by reference to FIG. 15. In step S601, a matrix for transforming the coordinate system for the subelement of the retrieval key into that for the display screen is obtained. The matrix, which is a 4 row, 4 column homogeneous transformation matrix, represents the position and posture of the retrieval key with respect to the display screen. In step S602, the 3D model from which only the subelement of the retrieval key has been removed is taken out from the whole of the 3D model in which the retrieval key has been set. In step S603, only “Cup B” 219 is taken out as data from the 3D model having “Cup B” 219 as a subelement. In step S604, the matrix obtained in step S601 is applied to the data on “Cup B” 219 taken out in step S603. As a result, “Cup B” 219 takes the same position and posture as those of “Cup A” 217, the retrieval key. Then, in step S605, the 3D form data of “Cup B” 219 transformed so as to take the same position and posture as those of the retrieval key in step S604 is combined with the 3D model from which the retrieval key taken out in step S602 has been removed. As for Cup C and Cup D, too, candidates for the results of retrieval where the retrieval key has been replaced with Cup C and Cup D by a similar approach to that of Cup B are outputted. According to the above-described procedure, a 3D model where the retrieval key has been replaced with the result of retrieval is formed and displayed.

Next, the effect of the third embodiment will be explained. In the 3D interior simulation system to which the third embodiment has been applied, when the result of retrieval is displayed, the retrieval key is replaced with the subelement determined to be similar to the result of retrieval on the 3D model in which the retrieval key has been set. Then, the result is displayed. That is, the 3D model displayed as the result of retrieval is in a state where interior simulation has been done. Therefore, the user can obtain the result of simulation using the result of retrieval in a smaller number of steps.

### FOURTH EMBODIMENT

Next, a fourth embodiment of the present invention will be explained. Since the configuration and operation of the fourth embodiment conform to the first embodiment, only the differences between them will be explained below. The fourth embodiment is such that the retrieving method of the retrieval section 24 and the method of displaying relationship information about the subelements set in a 3D model in the editing section 23 are made different from those in the first embodiment.

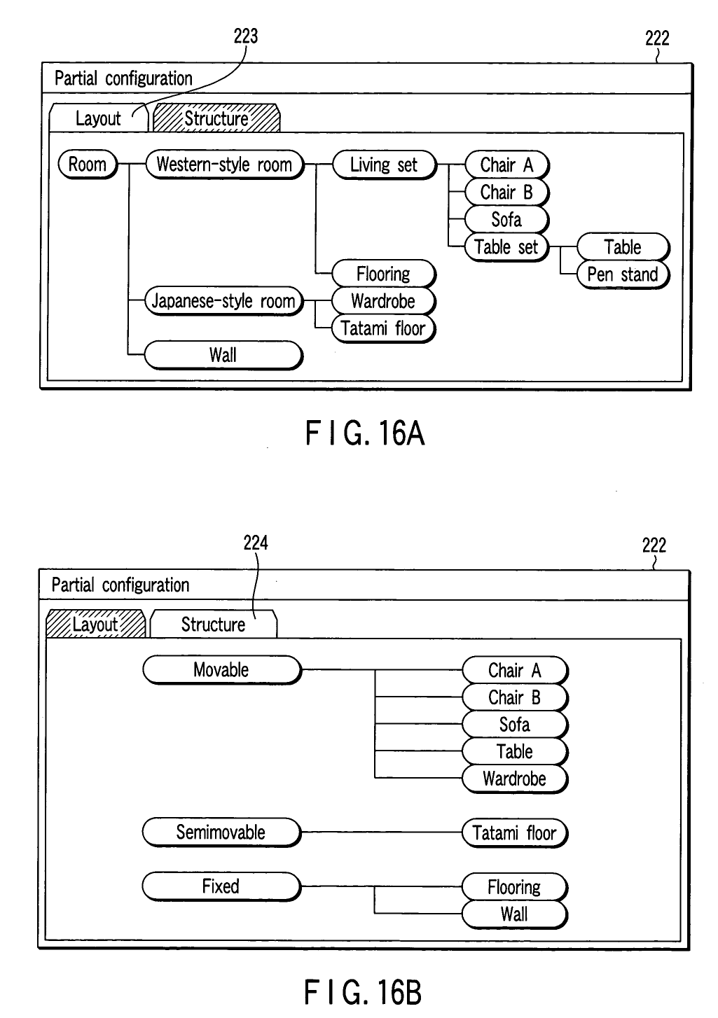

In the fourth embodiment, in place of the window 203 showing relationship information 110 about the subelements in the interior data 100 of FIG. 2 as shown in FIG. 3, a window 222 as shown in FIGS. 16A and FIG. 16B. That is, in the fourth embodiment, the interior data 100 has two types of relationship information. The window 222 is designed to switch between the two types of relationship information according to the selection of tubs 223, 224 by a click operation. FIG. 16A shows a case where tab 223 is selected. In FIG. 16A, relationship information focusing on the layout is shown. FIG. 16B shows a case where tab 224 is selected. In FIG. 16B, relationship information focusing on the structure is shown. As described above, the relationship information can be switched using the tabs 223, 224 in one window 222. In addition, it is possible to specify the relationship information to be retrieved. For example, the user can limit the object to be retrieved only to the relationship information with the structure shown in the tab 224.

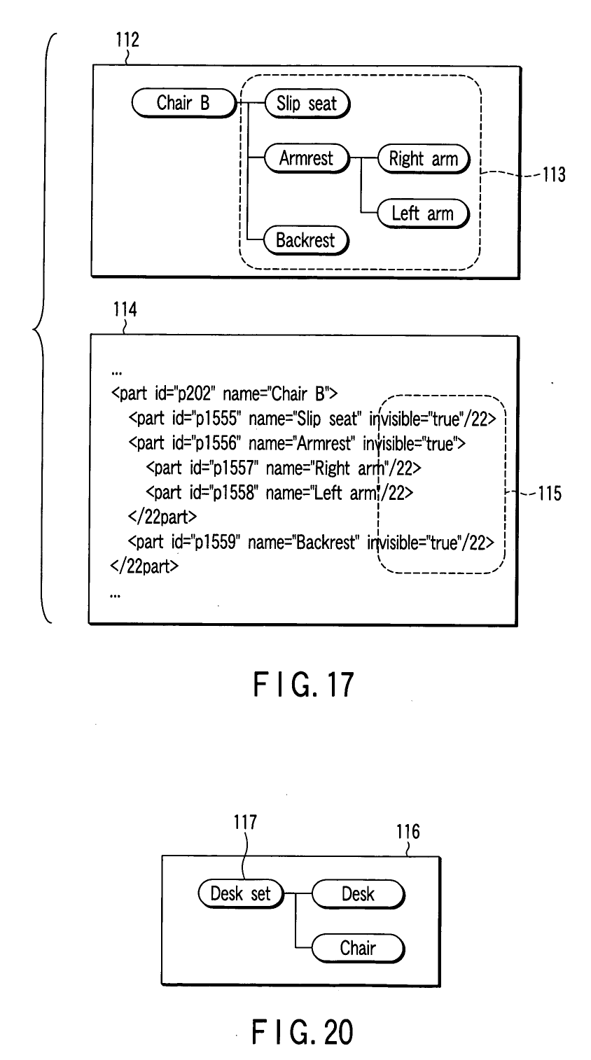

Furthermore, the interior data 100 holds subelements other than those shown in the tab 223 and tab 224 in the 3D form data. For example, Chair “B” 102 is composed of more detailed subelements as shown in a tree structure 112 of FIG. 17. In the tree structure 112, the subelements 113 not shown in the tab 223 and tab 224 have information 115 indicating whether they are represented as information in a format expressing subelements as shown in a data format 114. In the data format 114, “part id” represents the identification ID number of each partial model and its unique name and “invisible” identifier enables visible/invisible information about each model to be written as format information. Furthermore, the visible/invisible information can be changed by the user. Alternatively, the visible state and invisible state may be inevitably determined according to the situation in the display direction. In such a case, the visible/invisible information may be set automatically.

In the editing section 23, the data format 114 is reflected and the subelements 113 are not shown in the tab 223 and tab 224. Information about the data format 114 also exists in the 3D model stored in the database 21. Therefore, in the retrieval section 24, the data format 114 is reflected and the subelements having the data format 114 are removed from the objects to be retrieved.

Next, the effect of the fourth embodiment will be explained. In the 3D interior simulation system to which the fourth embodiment has been applied, displaying can be done using a plurality of pieces of relationship information set in a 3D model. When specifying a retrieval key, the user can determine a retrieval key by switching between the tab 223 and the tab 224 freely. Therefore, the user can grasp easily what relationship information the subelement specified as the retrieval key has and specify the retrieval key more accurately. In addition, a 3D model to be retrieved is limited only to specific relationship information, which enables the object to be retrieved to be narrowed down in advance. Thus, in the 3D interior simulation system to which the fourth embodiment has been applied, similarity search can be made efficiently and an interior item desired by the user can be provided. In addition, information indicating whether to display a subelement is held in the 3D model data. The information is used for display and retrieval. That is, subelements unnecessary as objects to be retrieved, such as the subelements 113, can be hidden. As a result, subelements so detailed that they are unsuitable for retrieval keys are not specified as retrieval keys, nor are the subelements included in the results of retrieval. This enables the desired interior items to be retrieved efficiently.

Relationship information about the subelements set in a 3D model may be not only information related to the form of a 3D model as shown in the tabs 223, 224 but also information unrelated to the form of a 3D model, such as agency information. In addition, the relationship information is not limited to a single tree structure and may include a plurality of tree structures or the recurrence relation between subelements. Furthermore, information indicating whether the object is a display element and information indicating whether the object is the one to be retrieved may be set independently.

### FIFTH EMBODIMENT

Next, a fifth embodiment of the present invention will be explained. Since the configuration and operation of the fifth embodiment conform to the first embodiment, only the differences between them will be explained below. The fifth embodiment is such that the retrieval method in the retrieval section 24 is made different from those in the first embodiment.

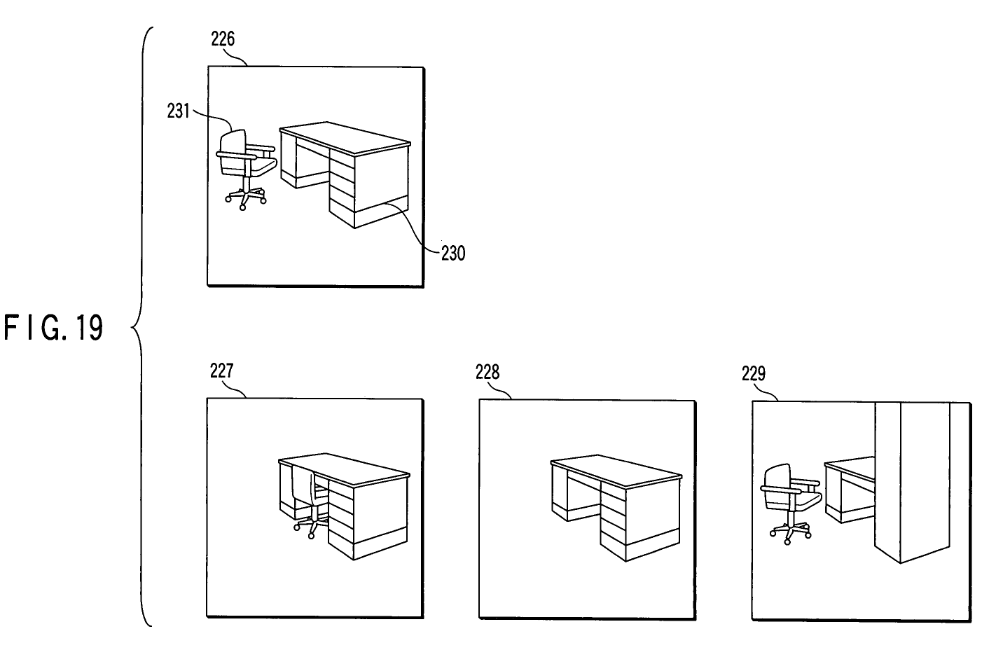

FIG. 19 shows a retrieval key 3D model 226 and retrieval object 3D models 227 to 229. The 3D model 227 is such that a disk similar to the disk 230 and a chair similar to the chair 231 in the retrieval key model 226 are arranged in a different layout from that of the retrieval key 3D model 226. The 3D model 228 includes only a disk similar to the disk 230 in the retrieval key 3D model 226. The 3D model 229 is such that a disk whose form is completely different from that of the disk 230 and a chair similar to the chair 231 in the retrieval key 3D model 226 are arranged in a layout similar to that of the retrieval key 3D model 226. When the retrieval key is specified at the editing section 23, a subelement including another subelement below its level as the disk set 117 can be specified from the relationship information 116 about the retrieval key 3D model as shown in FIG. 20. Here, the disk set 117 is specified as a retrieval key.

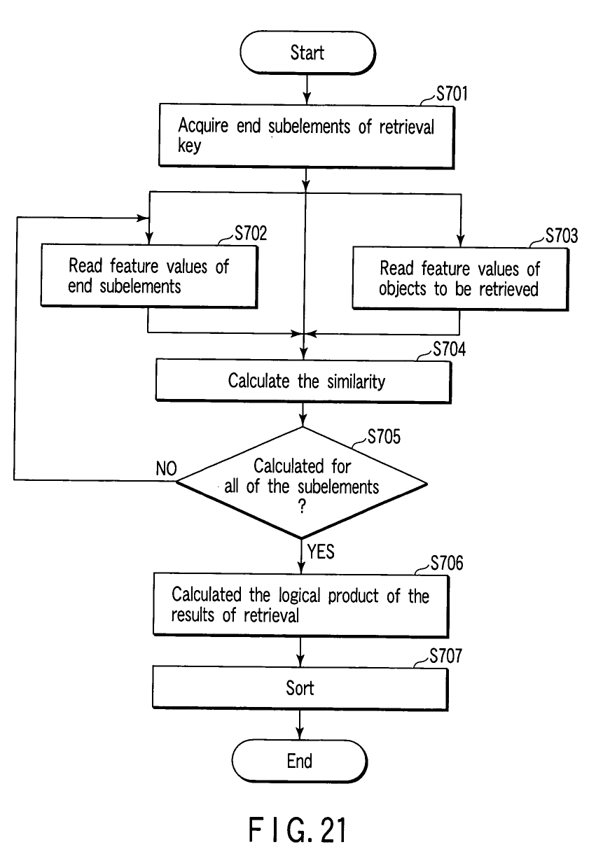

The retrieval section 24 retrieves a 3D model similar to the retrieval key according to the procedure shown in FIG. 21. That is, in step S701, the end subelements included in the retrieval key specified by the user are obtained. Since the disk set 117 has been specified as the retrieval key, the disk 230 and chair 231 are end subelements. In step S702, the feature values corresponding to one of the end subelements are read from the database 21. In step S703, the feature values about the 3D models 227 to 229 to be retrieved are read from the database 21. In step S704, the similarity is calculated. The calculating method is the same as in the first embodiment. In step S705, it is determined whether the similarity has been calculated for all of the subelements. If the similarity has not been calculated for all of the subelements, control returns to step S702.

Then, if the similarity has been calculated for all of the subelements, the logical product of the results of retrieval is calculated, thereby extracting the 3D model included in all of the lists corresponding to the individual subelements. As the results of retrieval of similarity with the disk 230, a subelement included in the disk set 117, the retrieval object 3D models 227 and 228 are obtained. In addition, as the results of retrieval of similarity with the chair 231, a subelement included in the disk set 117, the retrieval object 3D models 227 and 229 are obtained. That is, they are extracted in such a manner that only the 3D models including interior items similar to all of the subelements included in the retrieval key are obtained. Consequently, the retrieval object 3D model 227 is obtained as the result of retrieval of the disk set 117.

In step S707, the results of retrieval extracted in step S706 are sorted. In this case, since the extracted 3D models have the similarity corresponding to the individual subelements included in the retrieval key, the average value of them is determined to be the similarity of the 3D model. With this similarity as a reference, the extracted 3D models are ranked hierarchically.

Next, the effect of the fifth embodiment will be explained. In a conventional approach, when the disk set 117 is used as a retrieval key, similarities are retrieved using all of the subelements included in the disk set 117 as an integral 3D model. In this case, although the 3D model 227 has a desk similar to the disk 230 and a chair similar the chair 231 as subelements, it is evaluated as a different 3D model, because their relative positions are different from those of the disk set 117. In contrast, in the 3D interior simulation system to which the fifth embodiment has been applied, when the retrieval key specified by the user is a set of subelements, similarities are retrieved using each subelement as a retrieval key. As a result, when the disk set 117, a subelement combining the disk 230 and the chair 231 is specified as a retrieval key, a 3D model 227 which has a desk similar to the disk 230 and a chair similar to the chair 231 and differs from the disk set 117 in their relative positions can be obtained. That is, even if the individual subelements are in any positional relationship, they are not restricted by this and the results of retrieval aiming at the similarity of subelements can be obtained. Therefore, even when the user searches for similar interior items, focusing on a plurality of items, he or she can obtain the desired interior item easily.

### SIXTH EMBODIMENT

Next, a sixth embodiment of the present invention will be explained. Since the configuration and operation of the sixth embodiment conform to the first embodiment, only the differences between them will be explained below. The sixth embodiment is such that the retrieval key operation at the editing section 23 and the operation of the retrieval section 24 are made different from those in the first embodiment.

In the edit window the editing section 23 has, the 3D model selected from a catalogue, its subelements, and the retrieval result 3D model can be displayed in a three-dimensional space and the layout can be changed. In addition, the subelements of the 3D model in the window can be specified as retrieval keys.

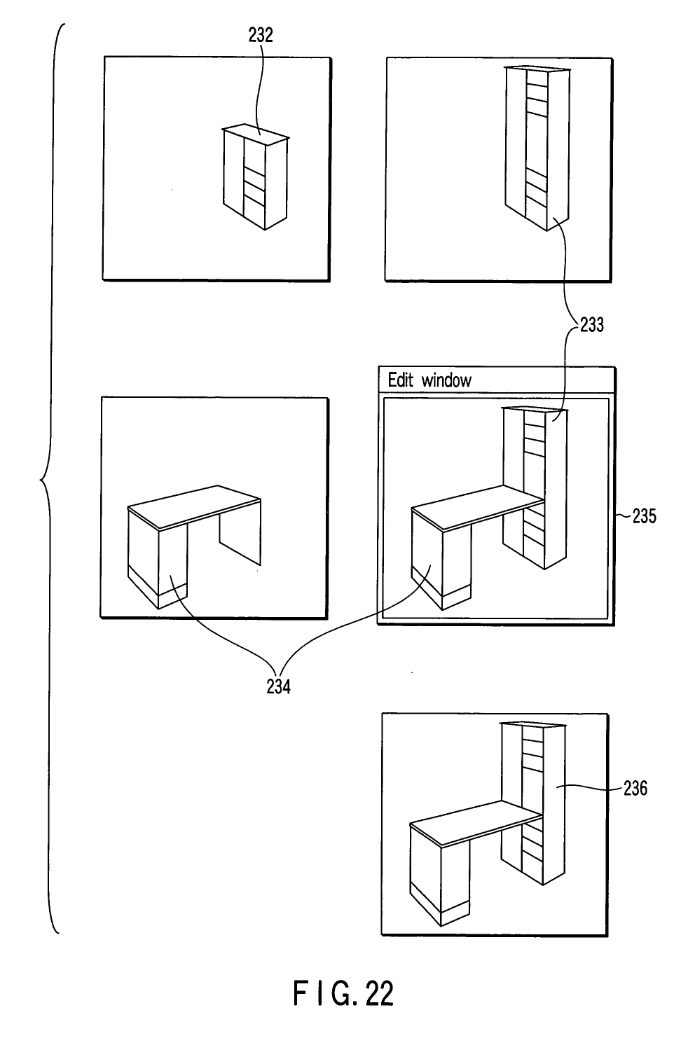

Furthermore, in the sixth embodiment, the 3D model, its subelements, and the retrieval result 3D model itself in the edit window can be edited. For example, as shown in FIG. 22, in the edit window, the height of “Cabinet A” 232, a subelement of the 3D model selected from the catalogue, can be changed to produce “Cabinet B” 233. In this editing process, the vertex coordinates of “Cabinet A” 232 are changed. In addition, for example, when “Cabinet B” 233 and the desk 234 are specified as retrieval keys, the editing section 23 converts these two into the same coordinate system. That is, a homogeneous transformation matrix for transforming the coordinate system of “Cabinet B” 233 into the coordinate system of the disk 234 is calculated. This matrix is applied to the vertexes of “Cabinet B” 233.

The operation of the retrieval section 24 is the same as the procedure of FIG. 7 except for step S201. Specifically, in the sixth embodiment, in place of reading the feature value in step S201, the feature value is calculated from “Cabinet B” 233 and the disk 234 specified as retrieval keys. The retrieval keys have been converted at the editing section 23 so as to be data in the same coordinate system. Therefore, the feature value is calculated for an integral 3D model. With this feature value as a reference, the retrieval section 24 searches for similarities. For example, when “Cabinet B” 233 and the disk 234 have been specified as retrieval keys in the window 235, a disk 236 similar to a form obtained by combining the subelements is obtained.

Next, the effect of the sixth embodiment will be explained. In the 3D interior simulation system to which the sixth embodiment has been applied, the user can not only select a retrieval key but also do editing. Therefore, it is possible to express the user's intention as a retrieval key more accurately. Consequently, it is possible to retrieve the desired interior item more efficiently and do interior simulation. In addition, in the 3D interior simulation system to which the sixth embodiment has been applied, it is possible not only to edit the form of a 3D model but also to construct a new 3D model by combining other 3D models. Therefore, the user can construct a 3D model representing the user's intention more accurately by using simple means for combining existing objects and retrieve similar interior items. Accordingly, interior simulation can be done more efficiently.

### SEVENTH EMBODIMENT

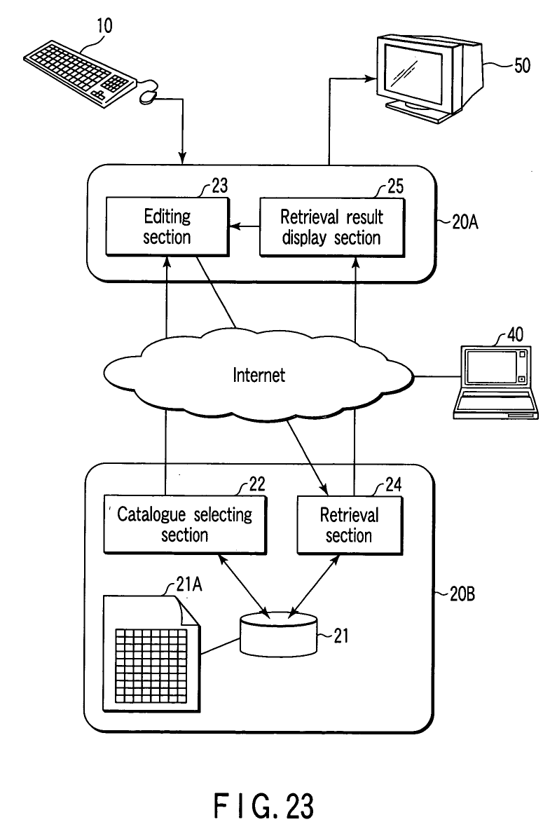

Next, a seventh embodiment of the present invention will be explained. FIG. 23 shows the configuration of an accessory order system to which a 3D model retrieval method and system according to the seventh embodiment have been applied. In FIG. 23, an input section 10 and an output section 30 are connected to a client system 20A. The input section 10 and output section 30 correspond to a keyboard, a mouse, and display in an ordinary computer system. The client system 20A is connected to a server system 20B via a network, such as the Internet. Another client system 40 is also connected to the server system 20B. That is, the seventh embodiment is such that a simulation section 20 as explained in the first embodiment is divided into the client system 20A and the server system 20B which are connected via a network, such as the Internet. Therefore, since the configuration and operation of the seventh embodiment conform to the first embodiment, only the difference between them will be explained below.

In a database 21 of the seventh embodiment, data about accessories has been registered. The accessory data includes 3D form data, feature values, and attribute information. The feature values, which are value data corresponding to the individual subelements of a 3D model, are obtained by processing form data about the subelements mathematically. For example, the feature values include features which have no direction with respect to the coordinate system a 3D model has, including the volume, the surface area, the vertex probabilitty distribution from the center of the 3D model along the radius, and the surface texture/color distribution, and features which have a direction with respect to the coordinate system a 3D model has, such as the torque of the vertex with respect to each of the X, Y, Z axes. The types of feature value are not limited to these. In the seventh embodiment, a table 21A for distinguishing between a feature having no direction and a feature having a direction is also registered in the database 21.

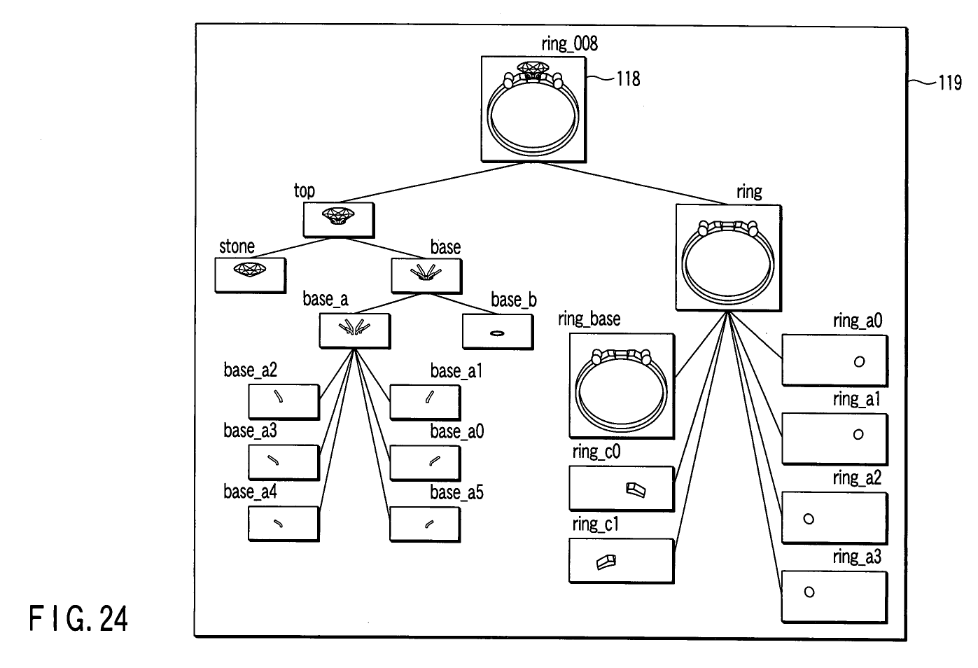

FIG. 24 shows an example of 3D form data. Specifically, a ring 118 is composed of a plurality of subelements according to a tree structure 119. Each subelement is also composed of 3D form data, feature values, and attribute information. The accessory data further includes information on the relationship between the subelements represented in the tree structure 119.

The editing section 23 can form a desired accessory by changing a part of the accessory or the like. At this time, it is possible to specify all of or a part of the accessory as a retrieval key and retrieve a similar accessory to the retrieval key.

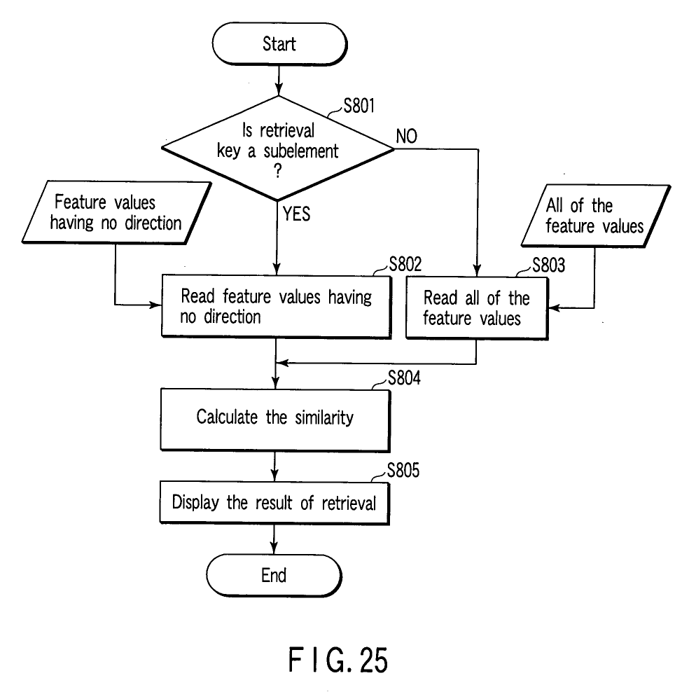

FIG. 25 shows the procedure for a retrieving process carried out at the retrieval section 24. Specifically, in step S801, it is determined whether the retrieval key is a subelement. If the retrieval key is a subelement, of the retrieval keys and the feature values of the targeted accessory data, in step S802, only the features having no direction are read from the database 21 on the basis of the table 21A registered in the database 21. In contrast, if it has been determined that the retrieval key is not a subelement, all of the feature values of the retrieval keys and targeted accessory data are read from the database 21 in step S803. That is, the feature values of the retrieval keys read in step S803 include not only features having no direction but also features having a direction. In step S804, from the feature values read in step S802 or step S803, the similarity of the targeted accessory data is calculated. The calculating method is the same as in the first embodiment. In step S805, the objects are rearranged in the order of similarity on the basis of the similarity obtained in step S804 and the result of retrieval is displayed on the display of the output section 30. The method of displaying the result of the retrieval is the same as in the first embodiment.

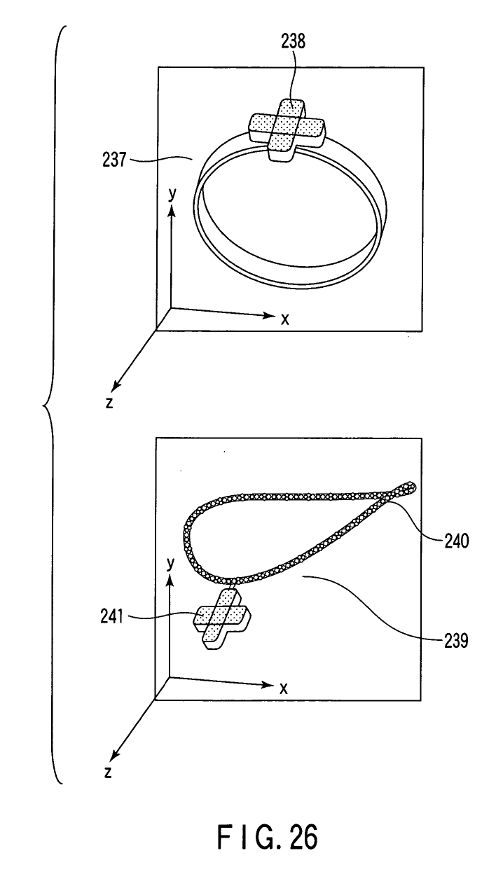

For example, when “Cross A” 238, a subelement of the ring 237 shown in FIG. 26 is specified as a retrieval key, the feature value is read in step S802. In addition, the feature value of a chain 240, a subelement of a necklace 239 or an item of the targeted accessory data, and the feature value of “Cross B” 241 are read in step S802. Although “Cross B” 241 has a different posture from “Cross A” 238 with respect to the 3D coordinate system, they have almost the same figure. In this case, since all of the feature values read have no direction, the similarity between “Cross A” 238 and “Cross B” 241 is high.

Next, the effect of the seventh embodiment will be explained. When a subelement of the 3D model is moved and rotated, the feature value having a direction takes a different value, since the subelement has a different direction, although it has the same form. In the conventional method, no distinction is made on the basis of the direction of the feature value and the similarity is calculated using all of the feature values. Therefore, it is difficult to determine that “Cross A” 238 is similar to “Cross B” 241. As a result, although the necklace 239 has “Cross B” 241, a subelement similar to “Cross A” 238 acting as a retrieval key, it is difficult to obtain the necklace 239 as the result of searching for similarities. In contrast, in the seventh embodiment, the feature values having a direction are distinguished from the feature values having no direction. Then, they are managed in the table 21A. When a subelement of a 3D model is specified as a retrieval key, similarities are searched for using only the features having no direction. As a result, it is possible to determine that “Cross A” 238 and “Cross B” 241 are similar and obtain the necklace 239 including “Cross B” 241 as the result of retrieval. Therefore, the user can obtain the desired accessory without paying attention to the direction of the retrieval key.

In addition, in the seventh embodiment, when the retrieval key is not a subelement but the whole of a 3D model, all of the feature values including the ones having a direction are read and similarities are searched for. Use of the feature values having a direction makes it possible to obtain the result of retrieval with high accuracy, focusing on the whole of the 3D model. Moreover, in the seventh embodiment, whether to use the feature values having a direction is determined automatically on the basis of whether the retrieval key is the whole of or a part of the 3D model. Therefore, the user can obtain a suitable result of retrieval according to the situation without paying attention to the type of feature value. The user may determine whether to use the feature values having a direction.

Furthermore, in calculating the similarity, the step of multiplying each feature value by a weighting factor expressing the degree of importance of the feature value may be added and the weighting factor corresponding to the feature value may be made zero when the feature values having a direction are not used. In calculating the similarity, there are features effective and ineffective in calculating the similarity in the feature values used in calculation. Therefore, a method of setting a higher weighting factor to an effective feature and a lower weighting factor to a less effective feature is effective in calculating the similarity. Thus, the method is included in the present invention in the form of a function.

As described above, the present invention has been explained using the above embodiments. This invention is not limited to the above embodiments and may be practiced or embodied in still other ways without departing from the spirit or essential character thereof. For instance, while in the embodiments, the explanation has been given about the cases where the present invention has been applied to a 3D interior simulation system and an accessory order system, it goes without saying that a 3D model retrieval method and system according to the invention may be applied to any system requiring the function of retrieving similar 3D models.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A 3D model retrieval method of retrieving a 3D model similar to the specified 3D model from a plurality of 3D models stored as objects to be retrieved in a database by using various feature values calculated from the selected 3D model, the 3D model retrieval method comprising:
specifying at least one of the selected 3D model and a subelement which is a part of the selected 3D model as a retrieval key;
acquiring the feature values of the subelements included in the 3D model specified as the retrieval key and data on information about the relationship between the subelements;
acquiring the feature values of the subelements included in the 3D models stored as objects to be retrieved in the database and data on information about the relationship between the subelements;
calculating the similarity between the 3D models to be retrieved and the 3D model acting as the retrieval key using the acquired feature values about the subelements to be retrieved, the acquired data on information about the relationship between the subelements, the acquired feature values about the subelements of the retrieval key, and the acquired data on information about the relationship between the subelements; and
displaying the result of retrieval on the basis of the calculated similarity.

2. The 3D model retrieval method according to claim 1, wherein the subelements of the 3D model are structured and
information on the structuring is the data on the relationship.

3. The 3D model retrieval method according to claim 2, wherein the calculating the similarity is using the feature values of the subelements at each of the hierarchical levels structured.

4. The 3D model retrieval method according to claim 2, wherein the specifying as a retrieval key includes specifying each of the subelements at the lowest level among the selected subelements as a retrieval key.

5. The 3D model retrieval method according to claim 4, wherein the calculating the similarity includes calculating the similarity between the subelements at the lowest level specified as the retrieval keys and the 3D model to be retrieved.

6. The 3D model retrieval method according to claim 1, wherein the 3D model has attribute information corresponding to the subelements, and
the displaying the result of retrieval includes displaying attribute information corresponding to the subelements at the same time.

7. The 3D model retrieval method according to claim 1, wherein the displaying the result of retrieval includes displaying the subelements in different form according to the similarity of the subelements of the 3D model determined by calculating the similarity.

8. The 3D model retrieval method according to claim 1, wherein the displaying the result of retrieval includes displaying a subelement whose similarity is the highest in different form from the other subelements.

9. The 3D model retrieval method according to claim 1, wherein the displaying the result of retrieval includes displaying a subelement of the 3D model specified as the retrieval key in different form from the other subelements.

10. A 3D model retrieval system which retrieves a 3D model similar to the specified 3D model from a plurality of 3D models stored as objects to be retrieved in a database by using various feature values calculated from the selected 3D model, the 3D model retrieval system comprising:
a catalogue selecting section configured to specify at least one of the selected 3D model and a subelement which is a part of the selected 3D model as a retrieval key;
a retrieval key feature values acquisition section configured to acquire the feature values of the subelements included in the 3D model specified as the retrieval key at the catalogue selecting section and data on information about the relationship between the subelements;
a retrieval object feature values acquisition section configured to acquire the feature values of the subelements included in the 3D models stored as objects to be retrieved in the database and data on information about the relationship between the subelements;
a degree-of-similarity computing section configured to calculate the similarity between the 3D models to be retrieved and the 3D model acting as retrieval key using the feature values about the subelements to be retrieved and data on information about the relationship between the subelements acquired by the retrieval key feature values acquisition section and the feature values about the subelements of the retrieval key and data on information about the relationship between the subelements acquired by the retrieval object feature values acquisition section; and
a display section configured to display the result of retrieval on the basis of the similarity calculated by the degree-of-similarity computing section.

11. A 3D model retrieval system which retrieves a 3D model similar to the specified 3D model from a plurality of 3D models stored as objects to be retrieved in a database by using various feature values calculated from the selected 3D model, the 3D model retrieval system comprising:
catalogue selecting means for specifying at least one of the selected 3D model and a subelement which is a part of the selected 3D model as a retrieval key;
retrieval key feature values acquiring means for acquiring the feature values of the subelements included in the 3D model specified as the retrieval key at the catalogue selecting means and data on information about the relationship between the subelements;
retrieval object feature values acquiring means for acquiring the feature values of the subelements included in the 3D models stored as objects to be retrieved in the database and data on information about the relationship between the subelements;
degree-of-similarity computing means for calculating the similarity between the 3D models to be retrieved and the 3D model acting as retrieval key using the feature values about the subelements to be retrieved and data on information about the relation-ship between the subelements acquired by the retrieval key feature values acquisition means and the feature values about the subelements of the retrieval key and data on information about the relationship between the subelements acquired by the retrieval object feature values acquiring means; and
display means for displaying the result of retrieval on the basis of the similarity calculated by the degree-of-similarity computing means.
